(19) United States
(12) Patent Application Publication
(10) Pub. No.: US 2008/0251956 A1
(43) Pub. Date: Oct. 16, 2008

(54) Embossing Device with a Deflection Compensated Roller

(75) Inventors: Raimo Korhonen, Tampere (FI); Pekka Koivukunnas, Jarvenpaa (FI)

Correspondence Address: VENABLE LLP, P.O. BOX 34385, WASHINGTON, DC, 20043-9998, US

(73) Assignee: AVANTONE OY, Tampere (FI)

(21) Appl. No.: 11/660,053

(22) PCT Filed: Aug. 5, 2005
(86) PCT No.: PCT/FI05/50287

§ 371 Date: Jun. 20, 2008

(30) Foreign Application Priority Data
Aug. 13, 2004 (FI) 20045294

(51) Int. Cl. B29D 11/00

(52) U.S. Cl. 264/1.9; 425/149

(57) ABSTRACT

A diffractive microstructure is produced on the surface layer of a substrate using an embossing device. The embossing device includes an embossing roll and a backing roll for exerting an embossing pressure on the surface layer of the substrate. The embossing pressure and/or variations in temperature cause deflection of the embossing roll. To compensate for the deflection, the embossing device can set the embossing pressure exerted by the central area of the embossing roll on the surface layer of the substrate to be at least equal to or higher than the embossing pressure exerted by the end areas of the embossing roll on the surface layer of the substrate.

The present invention relates to a method and device for producing a diffractive microstructure on the surface layer of a substrate by embossing, wherein said device comprises an embossing roll and a backing roll to exert embossing pressure on said surface layer of the substrate.

### BACKGROUND OF THE INVENTION

Diffractive microstructures may be attached to products for the visual effect given by them, or for authenticating the product.

Diffractive microstructures may be produced for example by embossing the surface layer of a substrate, which has been coated with a suitable lacquer. The coated substrate is pressed between an embossing member and a backing member in the embossing process, wherein the surface of the embossing roll comprises a relief corresponding to the microstructure. The embossing member and the backing member are e.g. rotating rolls. During the embossing process, the backing roll supports the substrate from the back side such that a sufficient pressure, the embossing pressure, may be exerted on the surface layer of the substrate in order to shape the surface to correspond to the relief of the embossing roll. It is advantageous for the shaping of the surface of the substrate if the surface layer is plasticized by heating. The temperature of the surface of the substrate during the embossing process is called herein the embossing temperature. The term embossing device is also used herein for a device performing the embossing.

U.S. Pat. No. 4,913,858 discloses a method for producing a diffractive microstructure on the surface layer of paper coated with a thermoplastic material. The microstructure is produced on the coating using a heated embossing roll.

The surface pressure required for producing the microstructure is typically quite high, and the forces directed to the rolls are correspondingly substantial. The side of a conventional roll on the substrate side bends under the effect of the embossing pressure and becomes concave. If the deflection is not compensated, the distance between the surfaces of the embossing roll and the backing roll, which are positioned against the substrate is not constant, but the distance is greater at the center of the rolls than at the ends of the rolls. Thus, the pattern depth of the microstructure is smaller at the center of the rolls than at the end areas. The substrate may also become unnecessarily compressed at the end areas of the rolls.

To prevent the deflection, the roll may be made very stiff by selecting the ratio between the diameter and the length of the roll to be great, by selecting the walls and the shafts to be thick, and by using rigid and stable materials. However, it should be noticed that if the substrate to be embossed comprises periodic features, such as printed pages, the period of the periodic features, such as the sheet size of the printed product sets constraints on the diameter of the rolls. Furthermore, it should be noticed that the pattern depth of the diffractive microstructure is in the order of the quarter of the wavelength of light, whereby even the slightest deflection is significant when compared to the produced pattern depth. The significance of the deflection is pronounced when materials, such as plastics are embossed in which materials the compression is small.

The uneven distribution of the embossing pressure resulting from the deflection of the rolls may be leveled to a certain extent by coating the backing roll with a compressible material, such as rubber.

### SUMMARY OF THE INVENTION

The main object of the present invention is to enable the production of a diffractive microstructure having an even pattern depth into a wide substrate. Another object of the present invention is to enable the use of slim rolls and to reduce the mass of the rolls.

To attain these objects, the device and method according to the invention are primarily characterized in what will be presented in the characterizing part of the appended independent claims. The dependent claims will present some preferred embodiments of the invention.

To attain these objects, the device according to the invention is primarily characterized in that the device comprises means for setting the embossing pressure exerted by the central area of the embossing roll on the surface layer of the substrate at least equal to or higher than the embossing pressure exerted by the end areas of the embossing roll on the surface layer of the substrate. The method according to the invention is primarily characterized in that the embossing pressure exerted by the central area of the embossing roll on the surface layer of the substrate is at least equal to or higher than the embossing pressure exerted by the end areas of the embossing roll on the surface layer of the substrate.

The embossing device according to the invention comprises advantageously means for controlling the deflection of the embossing roll and/or the backing roll such that the side of the embossing roll and/or backing roll at the substrate side may be adjusted to be at least straight or convex when examined from a direction perpendicular to the shaft of the roll.

In an advantageous embodiment the structural components determining the distribution of the embossing pressure are passive components. The shell of the backing roll is supported on the central zone of the shaft of the backing roll such that the ends of the shell may move in relation to the shaft of the backing roll. Thus, when the side of the embossing roll on the substrate side is bent under the embossing pressure and becomes concave, the side of the backing roll on the substrate side becomes convex in a corresponding manner. It is possible to affect the deflection produced by the embossing force by the dimensioning of the embossing roll and the backing roll such that the distance between the rolls in the central area of the rolls is equal or even smaller than the distance between the rolls in the end area of the rolls, even though both rolls are deflected. Thus, the pressure in the central area becomes equal to or higher than the pressure in the end areas.

The embossing device comprises advantageously two actuators connected to the ends of the shaft of the backing roll, the embossing force produced by the actuators causing the embossing pressure, which is exerted on the surface layer of the substrate through the backing roll. The spatial distribution of the embossing pressure may be advantageously adjusted also by using further actuators, which affect the ends of the shell of the backing roll. The possibility to adjust the spatial distribution of the embossing pressure is advantageous when e.g. deviations caused by the thermal expansion of the structures and manufacturing inaccuracies of the components are corrected.

In yet another embodiment, the deflection compensation may be implemented by using separate actuators affecting only the shell of the roll, for example by arranging several adjustable hydraulic slide bearings inside the shell.

The diameters of the rolls of the embossing device according to the invention do not have to be large and the rolls may be constructed such that their mass is moderate. If desired, the compressible coating of the backing roll may be selected to be very hard and thin, or it may even be omitted. This is advantageous for example in that respect that the tendency of the coating to spread sideways under the effect of the embossing pressure is reduced, and thus, the displacement of the substrate in the direction of the surface is minimized when producing the microstructure. Said displacement may degrade the produced microstructure.

By means of the embossing device according to the present invention, it is possible to produce diffractive microstructures with even pattern depths especially on wide substrates. This property is useful when the embossing device is used for example in combination with an operating printing machine. Then it is advantageous if diffractive microstructures may be produced at the same speed with the printing machine and on a substrate having the same width. Thus, the width of the substrate may be for example 1.5 meters. Naturally, it is possible to produce a microstructure on narrower substrates, wider substrates or several adjacent substrates. The deflection of the rolls is significant especially in wide rolls, because the forces required for the embossing are great and a wide roll bends more than a narrow roll having the same diameter.

The adjustability of the rolls of the embossing device according to some embodiments of the invention is also advantageous in a situation where the thickness of the substrate or its coating varies.

The invention and its fundamental properties as well as the advantages to be attained by means of the invention will become more evident for a person skilled in the art from the claims and the following description, in which the invention will be described in more detail by means of a few selected examples.

### BRIEF DESCRIPTION OF THE DRAWINGS

FIG. 1 shows schematically the producing of a diffractive microstructure on the surface layer of a substrate by embossing,

FIG. 2 shows schematically a diffractive microstructure produced on the surface layer of a substrate by embossing,

FIG. 3 shows an embossing device according to the present invention,

FIG. 4 illustrates deflection of rolls caused by the embossing forces,

FIG. 5 shows a deflection compensated backing roll according to the present invention and an embossing roll used as its mate,

FIG. 6 shows the principle of an optical measuring device measuring the diffracted light,

FIG. 7 shows a schematic diagram of an adjustment method of the embossing device according to the present invention, and

FIG. 8 shows a deflection compensated backing roll according to the present invention, in which the deflection is arranged to be adjustable by using actuators, and an embossing roll used as a mate for the backing roll.

### DETAILED DESCRIPTION OF THE INVENTION

### First Embodiment

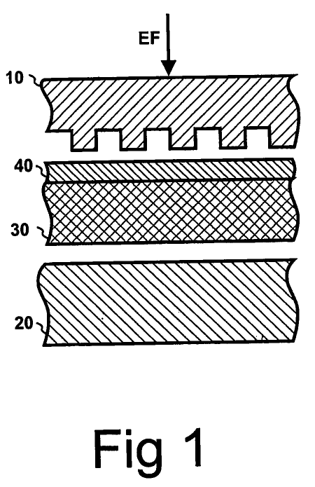

Referring to FIG. 1, a microstructure is produced on the surface layer 40 of a substrate 30 by pressing the substrate between an embossing roll 10 and a backing roll 20 such that the surface layer 40 of the substrate 30 is shaped to correspond to the relief on the surface of the embossing roll 10. The substrate 30 may be, for example, paper, cardboard or plastic. The surface layer 40 of the substrate 30 may consist of e.g. thermoplastic material, such as polyvinyl chloride, whose viscosity is reduced at high temperature. Examples of suitable surface materials are listed in U.S. Pat. No. 4,913,858. The diffractive microstructure may have e.g. rectangular, symmetrically triangular, asymmetrically triangular or sine-form profile.

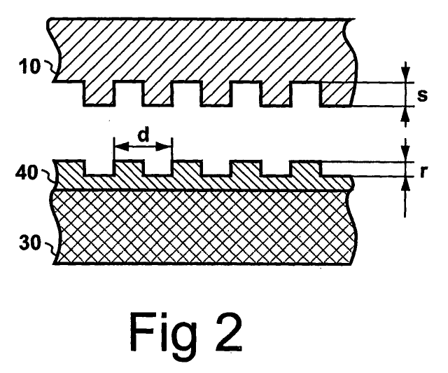

Referring to FIG. 2, the diffractive microstructure embossed on the surface layer 40 of the substrate 30 corresponds in its shape to the surface structure of the embossing roll 10. The structure is periodical such that a substantially similar shape recurs at least in one direction on the surface at positions separated by so-called grating constant d. The value of the grating constant and the orientation of the shapes may vary in different locations of the surface, wherein the desired diffractive effect or holographic pattern is obtained. For the produced microstructure it is possible to define the pattern depth r between the highest point and lowest point of the microstructure. It is possible to determine a pattern depth s for the embossing roll, respectively. It should be noticed that the maximum value of r is equal to s, and in practice r is slightly smaller than s.

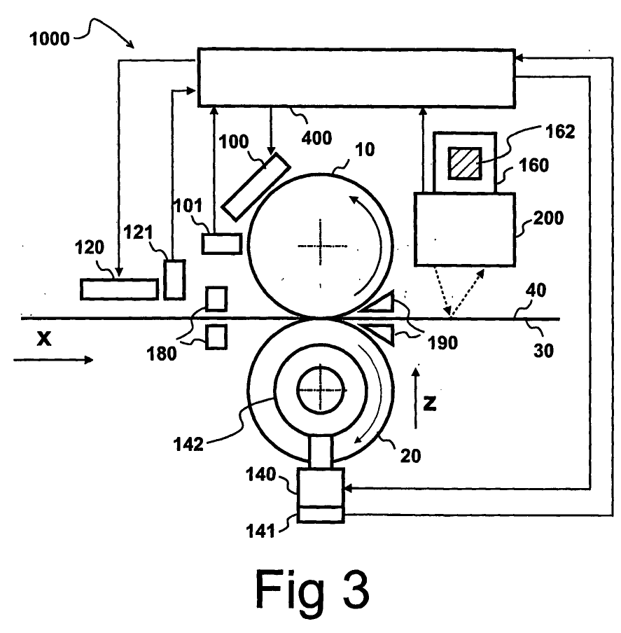

Referring to FIG. 3, the backing roll 20 is pressed against the embossing roll 10 in the direction z. The embossing roll 10 and the backing roll 20 are rotated by rotation mechanisms. Thus, the substrate 30 moves in the direction x, and is pressed between the embossing roll 10 and the backing roll 20.

The embossing pressure exerted by the embossing roll 10 and the backing roll 20 on the surface layer 40 of the substrate 30 is adjusted by means of two actuators 140 connected to the bearings 142 of the backing roll 20, which actuators may be for example hydraulic cylinders. In connection with the actuators there are sensors 141 monitoring the embossing force, i.e. monitoring indirectly the embossing pressure as well.

The combined thickness of the substrate 30 and the coating 40 may be monitored for example by means of a measuring device 180 based on optical interference or triangulation. The variations in the thickness may thus be taken into account in advance, and the distance between the rolls 10, 20 may be adjusted in a corresponding manner. The distance between the rolls and/or the shape of the rolls may be measured using a measuring device 190 which may have an optical operating principle.

An optical measuring device 200 is advantageously arranged to measure the intensity of light diffracted from the surface 40 of the substrate in the first diffraction order. The signal 221 of the measuring device 200 depends on the pattern depth r of the produced microstructure. The adjustment of the embossing forces generated by the actuators 140 may be at least partly based on the signal 221 of the optical measuring device 200. If required, the measuring device 200 may be moved laterally by means of a transfer mechanism 160 along a guide 162, for monitoring the entire surface of the substrate 40.

The embossing temperature may be controlled by adjusting the power of infrared heaters 120 heating the surface layer 40 of the substrate 30 and/or by adjusting the power of inductive heaters 100 heating the surface of the embossing member 10. The temperatures are monitored by pyrometric measuring devices 101, 121. The embossing roll 10, the backing roll 20 and/or the rotating mechanism have sensors for determining the angular position and the rotating speed.

A control unit 400 controls the temperature control means 100, 120 and/or the pressure control means 140 by on-line adjustment on the basis of a signal 221 of the optical measuring device 200. The arrangement for controlling the embossing pressure and/or the embossing temperature and comprising the optical measuring device 200 is advantageously feedback coupled; in other words, it forms a closed loop control circuit. Measuring data from temperature sensors 101, 121 and other sensors are also utilized for the control.

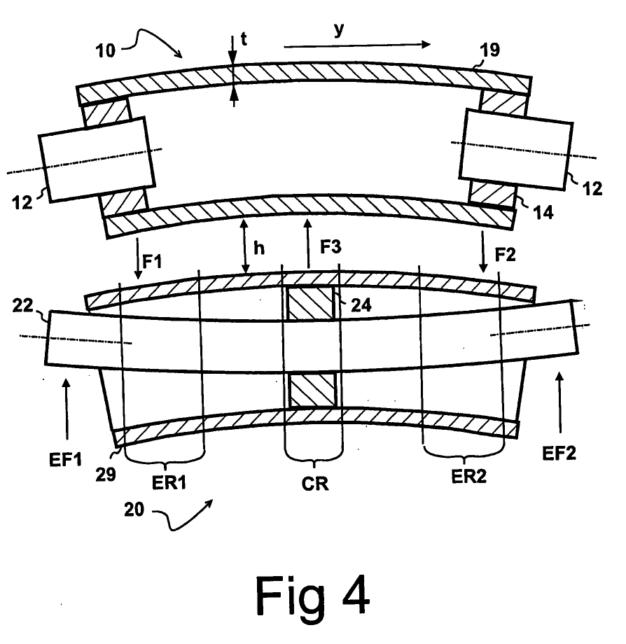

FIG. 4 illustrates the deflection of the rolls 10, 20 during the embossing process. The shell 19 of the embossing roll 10 is supported on the shaft or shafts 12 at least via end flanges 14. The shell 29 of the backing roll 20 is supported through a flange 24 on the shaft 22 of the backing roll within the central zone CR, wherein the ends of the shell 29 are capable of moving in relation to the shaft 22 located inside the backing roll. Between the embossing roll 10 and the backing roll 20 there is a substrate 30 (not shown in FIG. 4). Forces EF1, EF2 are exerted on the ends of the shaft of the backing roll, said forces pressing the backing roll against the substrate 30.

The shell 19 of the roll bends when the value of the embossing pressure differs substantially from zero. The ends of the shell of the backing roll 20 can move in relation to the shaft 22 of the backing roll in the end areas ER1, ER2 such that the distance h between the rolls 10, 20 becomes substantially equal both in the end areas ER1, ER2 and in the central area CR. The backing roll 20 exerts through the substrate 30 at least a force F3 on the embossing roll 10, said force bending the side of the embossing roll on the substrate side into a concave shape. The embossing roll 10 exerts at least forces F1 and F2 on the backing roll 20, said forces bending the side of the backing roll on the substrate side into a convex shape.

The wall thickness t of the shells 19, 29 of the rolls 10, 20 does not have to be constant. A person skilled in the art can determine the dimensions at different locations of the rolls 10, 20 experimentally or by means of calculations on the basis of the properties of the materials in such a manner that the distance h between the rolls 10, 20 in the central area CR becomes substantially equal to that of the end areas at least one value of the embossing pressure.

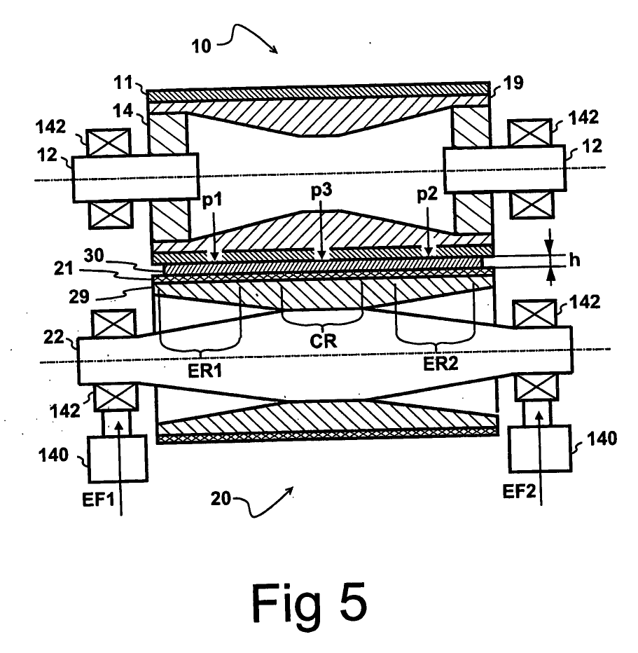

With reference to FIG. 5, the embossing forces EF1, EF2 generated by the actuators 140 are transmitted to the shaft 22 of the backing roll 20 by bearings 142. The surface of the embossing roll 10 exerts an embossing pressure on the surface layer 40 of the substrate 30, said pressure having a spatial distribution. Especially a first point within the first end area ER1 exerts a first embossing pressure p1 on the surface layer 40, a second point located within the second end area ER2 exerts a second embossing pressure p2 on the surface layer 40, and a third point located between said first and second point exerts a third embossing pressure p3 on the surface layer 40. Said third point is located for example in the central area CR of the embossing roll. The backing roll has such an internal structure that said third embossing pressure p3 becomes advantageously as high as said first embossing pressure p1 and said second embossing pressure p2.

The rolls 10, 20 are advantageously dimensioned such that the embossing pressure p3 in the central area CR becomes substantially as high as the embossing pressure p1, p2 in the end areas ER1, ER2 within a wide range of embossing pressures. However, the rolls 10, 20 may also be dimensioned such that the embossing pressures cause a larger deflection in the backing roll 20 than in the embossing roll 10. Furthermore, if the outer surface 10 of the embossing roll 10 is provided with a slightly concave shape and/or the outer surface of the backing roll 20 with a slightly convex shape, it is possible to adjust the forces EF1 and EF2 affecting the ends of the shaft 22 of the backing roll to set the embossing pressure p3 within the central area CR to be higher than, equal to or lower than the embossing pressure within the end areas ER1, ER2.

The surface 21 of the backing roll 20 may also be coated for example with epoxy resin or rubber to correct the local deviations in the spatial distribution of the embossing pressure and to increase the effective area of the embossing pressure.

On the embossing rolls 10 there may be for example a cylinder 11 made of a nickel-based material, on which reliefs corresponding to the desired microstructure have been produced by optical and electrolytic methods. A method for manufacturing an embossed plate is disclosed, for example, in U.S. Pat. No. 3,950,839. The embossed plate is bent and welded to form a cylinder 11, which is placed on top of a roll. Such a method for bending and welding a cylinder is described for example in the U.S. Pat. No. 6,651,338. The substrate 30 and its surface layer 40 are pressed during the rotation of the rolls such that a microstructure is formed on the surface layer 40.

The embossing pressure is advantageously in the order of 0.5 MPa. However, the embossing pressure may be as high as 20 to 50 MPa. The deflection of the shell 11 of the embossing roll 10 corresponding to a predetermined embossing pressure depends e.g. on the bearing distance, i.e. the distance between the bearings 142 and on the diameter of the rolls. When diffractive microstructures are produced for example on letter-sized substrates according to the A4 or US standard, the bearing distance of the required embossing roll 10 is larger than 0.2 meters. When diffractive microstructures are produced for example in posters, a roll having a bearing distance of over 1 meter may be required. If the aim is to cut the substrate 30 for example into sheets of standard size, it is advantageous to select the perimeter of the embossing roll 10 such that it corresponds to the dimension of the sheet in the travelling direction x of the substrate 30. The deflection is especially significant in slim rolls. In this context, the term slim roll refers to a roll in which the ratio of the bearing distance to the diameter is larger than or equal to 0.5.

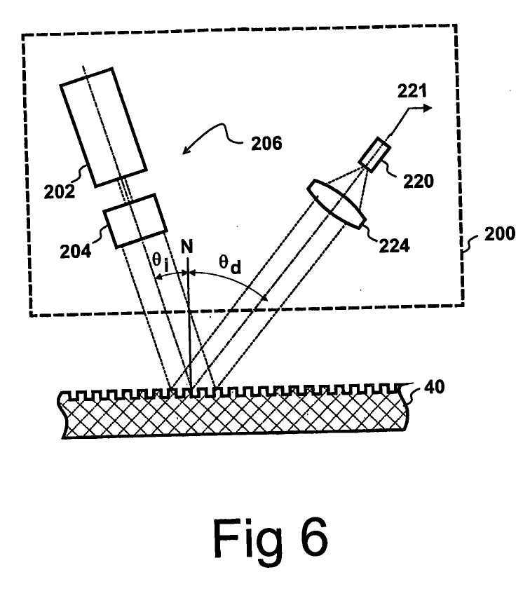

With reference to FIG. 6, the above-mentioned optical measuring device 200 comprises a light source 206 for illuminating the surface 40 of the substrate 30 and a light detector 220 for determining the intensity of the diffracted light. The light-emitting element 202 of the light source 206 may be, for example, a laser, which emits monochromatic light. The light-emitting element 202 and the optical element 204 together form the light source 206. The light detector 220 may be e.g. a light diode. The optical element 204 of the light source 206 may be e.g. a lens or a beam expander by which the light is directed to a target area with a given size and shape. The optical element 224 connected to the light detector 220 may be e.g. a lens for collecting light into the detector 220 from an area to be examined. Said optical element 224 together with the light detector 220 define the direction of monitoring and the area of monitoring for the detector 220. A signal 221 provided by the light detector 220 depends on the pattern depth r of the microstructure 30 within the target area on the surface 40 of the substrate 30 monitored at a given time.

The direction of illumination and the direction perpendicular to the surface of the substrate form the angle of illumination θᵢ. The direction of viewing and the direction perpendicular to the surface layer of the substrate form the angle of viewing θ_{d}. The measuring device 200 comprises means for setting the desired angle of illumination θᵢ, and the angle of viewing θ_{d}.

It is known that the intensity of diffracted light has a maximum at angles of illumination and viewing which fulfill the equation:

nλ=d(sin θ_{d}−sin θᵢ) (1)

where n is an integer indicating the order of diffraction and A is the wavelength of light. The grating constant d was defined above.

It is advantageous to set the angle of illumination and the angle of viewing to meet the condition set by equation 1. It is particularly advantageous to set the angle of illumination θᵢ and the angle of viewing θ_{d} such that the equation 1 is fulfilled at values of n at −1 or 1 (the first diffraction order).

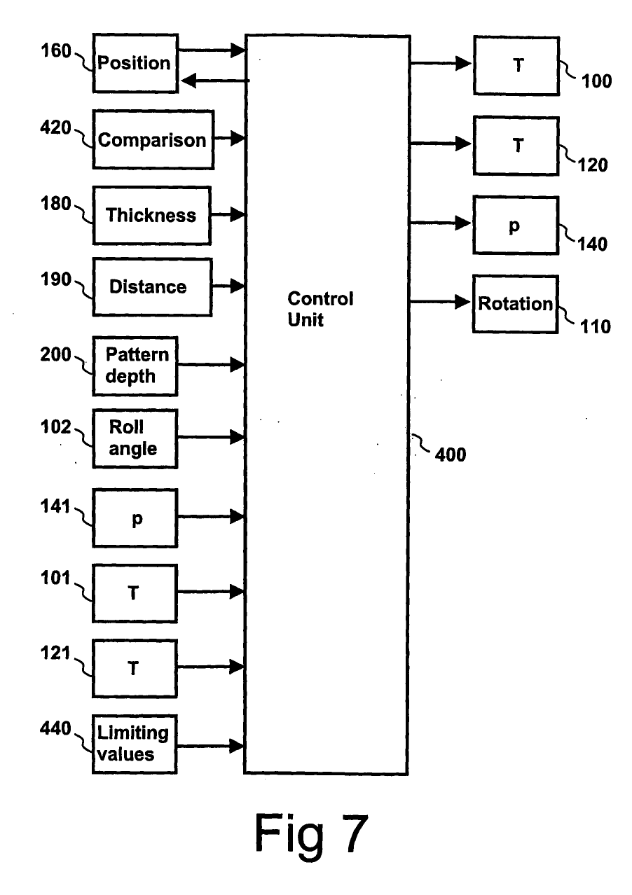

Referring to FIG. 7, the control unit 400 controls the values of temperatures, pressure and speed of rotation of rolls at least partly on the basis of the signal 221 of the optical measuring device 200. If required, the control unit 400 also communicates also with other simultaneous processes, such as a printing process or a coating process, to attain problem-free co-operation. The control unit 400 monitors the signals of various sensors and measuring devices. The control unit 400 takes care of the protective measures of the system and alarms in failure situations.

The mechanism 160 for moving the optical measuring device 200 and the position sensor 102 of the embossing roll provide information about the position of the point or area of monitoring of the measuring device 200 in relation to the substrate. On the basis of the position, a relevant reference value is selected for the signal from a reference value file 420. In the control unit 400, the signal 221 of the optical measuring device 200 is compared with the reference value. The reference value may be e.g. 90% of the signal level, which would be attained if the pattern depth r of the microstructure would be exactly equal to the pattern depth s of the embossing roll 10. For example, if the signal 221 from the optical measuring device 200 is higher than the target level, the embossing pressure is reduced. This is achieved by reducing the embossing force generated by the actuator 140 affecting the backing roll.

In said situation, it is also possible to reduce the temperature of the surface of the embossing roll 10. This may be achieved by reducing the heating power of the heating element 100 of the embossing roll. A temperature sensor 101 is also utilized for adjusting the temperature. Alternatively, it is also possible to increase the speed of rotation of the mechanism 110 for rotating the embossing roll. It is also possible to use combinations of different control measures, for example both a change in the temperature and a change in the pressure. In the control, information on the position and the speed of rotation, obtained from the position sensor 102 of the embossing roll, and information from the sensors of the embossing pressure 141, connected to the actuators 140, is utilized. The temperature of the surface 40 of the substrate may also be adjusted by using the heating element 120 and the temperature sensor 121.

However, it is not practical to exceed certain limiting values of the parameters. A limiting value may be determined for the embossing pressure such that the substrate 30 or its surface layer 40 collapses or escapes from below the embossing roll 10 at pressures higher than the limiting value. The limiting value for the embossing pressure may also be defined as a function of the temperature and the embossing time. The limiting values are stored in a limiting value file 440 where they are available for the control unit 400. The control unit 400 controls the embossing device such that the limiting values are not exceeded.

### Further Embodiments

The surface 40 of the substrate may comprise several zones containing a similar or different diffractive microstructure to provide a desired colour effect, motion effect, two-dimensional pattern, pattern depending on the direction of viewing, animation, pattern providing a three-dimensional impression, or visually invisible microstructure. Part of the surface may be left unembossed. The surface may also comprise patterns or symbols produced with a dye. These may be produced before, simultaneously with or also after the embossing. The patterns provided with a dye and the produced microstructures may overlap in whole or in part.

The microstructure may also be embossed on printing ink as disclosed in U.S. Pat. No. 5,873,305. The substrate 30 and its surface layer 40 may consist entirely of the same material. The embossed surface layer 40 may be coated with a metal film to enhance the visual effect. Moreover, the surface layer 40 of the substrate 30 may consist of a UV curable lacquer. The embossed surface layer 40 may be coated with a transparent protective film.

The spatial distribution of the embossing pressure at different positions of the surface 40 of the substrate may be uneven not only because of the deflection of the rolls 10, 20 caused by the embossing forces, but also because of the variations in the thickness of the substrate 30 and its surface layer 40, and because of the gravitation or thermal expansion affecting the rolls 10, 20. The distance h between the rolls 10, 20 and/or the pattern depth r of the microstructure produced on the surface layer 40 of the substrate 30 may be monitored at different positions by means of an optical measuring device 200. The deflection of the rolls 10, 20 may be arranged to be adjusted on the basis of the information produced by measuring devices, for example the optical measuring device 200.

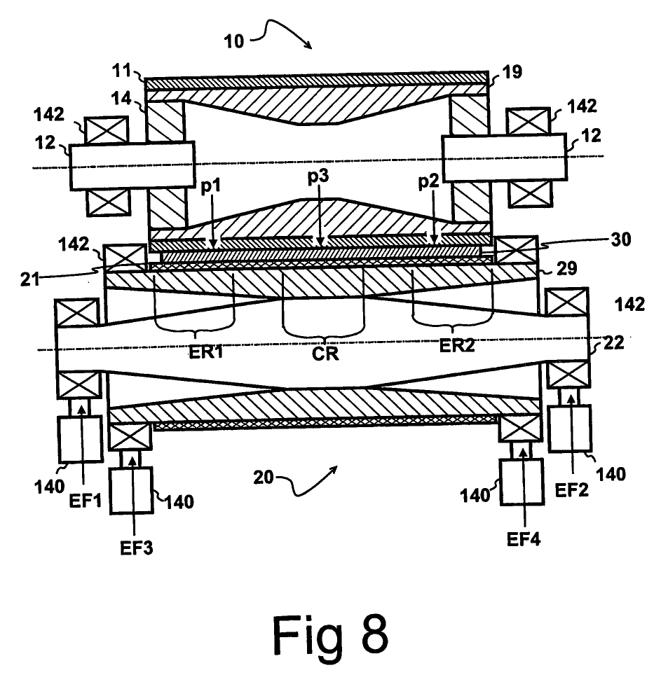

FIG. 8 illustrates the adjustment of the deflection of the backing roll 20 by using actuators, which affect the ends of the shell 29 of the backing roll 20 through bearings 142. Said actuators 140 direct forces EF3 and EF4 to the ends of the shell 29 of the backing roll 20. The actuators producing the forces EF1 and EF2 affect the embossing pressure primarily in the central area CR of the rolls 10, 20 and the actuators producing the forces EF3 and EF affect the embossing pressure primarily in the end areas ER1, ER2 of the rolls 10, 20. Thus, it is possible to affect the spatial distribution of the embossing pressure and the produced pattern depth using separate actuators. The adjustment according to FIG. 8 also enables more accurate local adjustment of the distance between the rolls and the local adjustment of the embossing pressure in the end areas ER1, ER2 of the rolls. Thus, it is possible to affect the spatial distribution of the embossing pressure separate actuators. It is advantageous to perform such an adjustment for example when the value of the embossing pressure is substantially changed.

Alternative ways of implementing deflection compensated rolls are also disclosed e.g. in the book by Mikko Jokio: Papermaking Science and Technology, Part 3, Fapet Oy, 1999 (ISBN952-5216-10-1). There may several separately controlled zones in the deflection compensated roll, wherein such a roll is also called a zone-controlled roll. Such a roll may be implemented for example by placing several separately adjustable hydraulic slide bearings inside the roll, in other words actuators 140 in which the adjustment is performed for example by affecting the pressure of oil between the slide surfaces, the flow rate and/or the flow geometry.

The embossing device according to the present invention may be implemented also in such a manner that neither of the rolls 10, 20 is substantially bent during the embossing process. Such an embodiment may be implemented for example such, that both the embossing roll 10 and the backing roll 20 are zone-controlled. Alternatively, such an embodiment may be implemented such that the structure and adjustment possibilities of both rolls 10, 20 correspond to the structure and adjustment possibilities of the backing roll 20 shown in FIG. 8.

In addition to hydraulic cylinders, the actuators 140 affecting the embossing pressure and/or the deflection of the roll may also be pneumatic cylinders. The actuators 140 may also operate on the electromechanical principle. Because the adjustment movement is very short, the adjustment may also be performed by actuators 140 based on thermal expansion of metals or ceramics, or by actuators 140 based on memory metals. Furthermore, the actuator 140 may be fully manual in such a way that, for example, no electric, hydraulic or pneumatic auxiliary energy is needed for performing the adjustment. Instead of the backing roll 20, the actuators 140 may affect the embossing roll 10. The actuators 140 may affect both the embossing roll 10 and the backing roll.

The heating of the embossing roll 10 may also be based on a heat transfer medium circulating inside the roll 10, such as oil. The embossing device 1000 may also comprise inductive heaters 100 or auxiliary rolls heated by electricity or by a heat transfer medium. The embossing roll 10 may comprise thermoelements and pressure sensors for monitoring the pressure and the temperature.

Instead of epoxy resin or rubber, the surface layer 21 of the backing roll 20 may consist of another compressible material, such as material containing cells or fibers, gas-filled material or fluid-filled material. The backing roll 20 may also be uncoated, which requires partial compressibility of the substrate or very accurate adjustment of the embossing device 1000.

The adjustment of the embossing device 1000 may be performed automatically such that the control operations are carried out on the basis of the absolute value of the measuring signal, the relative variations of the measuring signal, or the difference between the measuring signal and a reference value. The adjustments may be implemented as the so-called PID control, whereby the adjustment is carried out on the basis of the difference between the real value and the target value, on the basis of the time integral of said difference, and/or on the basis of the time derivative of said difference.

The adjustment may also be implemented as so-called fuzzy control on the basis of the measuring signals.

Furthermore, the adjustment may be manual so that the user of the embossing device 1000 watches a display to monitor the signals of the measuring devices, especially the signals of an optical measuring device 200 or the values of parameters computed from them, and performs the control operation manually.

Other embodiments of the optical measuring device 200 are also presented in the patent application “An embossing device and a method for adjusting the embossing device” filed simultaneously with the present patent application.

The invention is not limited solely to the embodiments presented in the above description and in the drawings. The aim is to limit the invention only by the presentation of the scope of the appended claims.

1-21. (canceled)

22. A device for producing a diffractive microstructure on the surface layer of a substrate, said device comprising at least an embossing roll and a backing roll for exerting an embossing pressure on said surface layer of the substrate, wherein
in a first end area on the outer surface of the embossing roll a first point is arranged to exert a first embossing pressure on the surface layer of the substrate,
in a second end area on the outer surface of the embossing roll a second point is arranged to exert a second embossing pressure on the surface layer of the substrate,
a third point located between said first point and said second point on the outer surface of the embossing roll is arranged to exert a third embossing pressure on the surface layer of the substrate, and
said device further comprises means for setting said third embossing pressure at least equal to or higher than said first embossing pressure and said second embossing pressure,
wherein said embossing roll and/or backing roll comprises a cylindrical shell and a shaft inside said shell, said shell and said shaft being connected to each other in the central area of said embossing roll and/or backing roll such that the position of the ends of said shell is changeable in relation to said shaft inside said shell, said device comprising at least one actuator to affect the embossing pressure at least locally, and wherein said shaft and said shell are together rotatable with respect to said at least one actuator.

23. The device according to claim 22, wherein the embossing pressure exerted by said embossing roll on said surface layer of the substrate is arranged to be separately adjustable at least in said first point, in said second point and in said third point.

24. The device according to claim 22, wherein it comprises at least one actuator affecting the embossing pressure at least locally, said actuator having a manual, hydraulic, pneumatic and/or electromechanical operating principle and/or said actuator being based on the use of memory metal.

25. The device according to claim 22, wherein said device comprises at least one measuring device, which is arranged to directly or indirectly measure the embossing pressure exerted by the embossing roll on said surface layer of the substrate.

26. The device according to claim 22, wherein said device comprises at least one measuring device, which is arranged to measure the total thickness of the substrate and its surface layer.

27. The device according to claim 22, wherein said device comprises at least one optical measuring device, which is arranged to measure light diffracted from the surface of the substrate, and wherein the embossing pressure is arranged to be adjusted at least partly on the basis of the signal produced by said optical measuring device in at least one position of the surface layer of said substrate.

28. The device according to claim 22, wherein the surface of the backing roll is provided with a partially compressible surface layer.

29. The device according to claim 28, wherein the partially compressible surface layer on the surface of the backing roll consists of epoxy resin or polymer.

30. The device according to claim 22, wherein said device comprises means for heating the surface layer of the substrate.

31. The device according to claim 30, wherein the spatial temperature distribution on the surface layer of the substrate is adjustable.

32. The device according to claim 22, wherein said device comprises means for heating the surface layer of said embossing roll.

33. The device according to claim 32, wherein the spatial temperature distribution on the surface layer of said embossing roll is adjustable.

34. The device according to claim 22, wherein the distance between the bearings of said embossing roll is greater than or equal to 0.2 meters.

35. The device according to claim 22, wherein the distance between the bearings of said embossing roll is greater than or equal to one meter.

36. The device according to claim 22, wherein the perimeter of said embossing roll is selected from the following list: the height of a standard-size A4 sheet (29.7 cm), multiple of the height (29.7) of a standard-size A4 sheet, width of a standard-size A4 sheet (21 cm), multiple of the width (21 cm) of a standard-size A4 sheet, height of a standard-size letter sheet (27.9 cm), multiple of the height (27.9 cm) of a standard-size letter sheet, width of a standard-size letter sheet (21.6 cm) and multiple of the width (21.6 cm) of a standard-size letter sheet.

37. The device according to claim 22, wherein the ratio between the diameter of said embossing roll and the length of said embossing roll is smaller or equal to 0.5.

38. The device according to claim 22, wherein said embossing roll is at least in one point arranged to exert an embossing pressure on the surface layer of the substrate, which embossing pressure is higher than or equal to 0.5 MPa.

39. A method for producing a diffractive microstructure on the surface layer of a substrate, said method comprising exerting an embossing pressure on said surface layer of the substrate by using an embossing roll and a backing roll, wherein
in the first end area on the outer surface of the embossing roll a first point exerts a first embossing pressure on the surface layer of the substrate,
in the second end area on the outer surface of the embossing roll a second point exerts a second embossing pressure on the surface layer of the substrate, and
a third point located between said first point and said second point on the outer surface of the embossing roll exerts a third embossing pressure on the surface layer of the substrate, such that said third embossing pressure is equal to or higher than said first embossing pressure and said second embossing pressure, wherein said embossing roll and/or backing roll comprises a cylindrical shell and a shaft inside said shell, said shell and said shaft being connected to each other in the central area of said embossing roll and/or backing roll such that the position of the ends of said shell is changeable in relation to said shaft inside said shell, wherein at least one actuator affects the embossing pressure at least locally, and wherein said shaft and said shell are together rotatable with respect to said at least one actuator.

40. The method according to claim 39, wherein the distance between the bearings of said embossing roll is greater than or equal to 0.2 meters.

41. The method according to claim 39, wherein the perimeter of said embossing roll is substantially equal to a predetermined height or width of a sheet.

42. The method according to claim 39, wherein the embossing pressure exerted by said embossing roll on said surface layer of the substrate is in at least one point higher than or equal to 0.5 MPa.
